(19) United States
(12) Patent Application Publication
(10) Pub. No.: US 2024/0343130 A2
(43) Pub. Date: Oct. 17, 2024

(54) SYSTEMS AND METHODS FOR WIRELESS POWER TRANSFER

(71) Applicant: EM Power Solutions Inc., Edmonton (CA)

(72) Inventors: Konrad WORONOWICZ, Kingston (CA); Carl Aaron Peter WRIGHT, Edmonton (CA)

(21) Appl. No.: 18/519,411

(22) Filed: Nov. 27, 2023

Related U.S. Application Data
(60) Provisional application No. 63/385,129, filed on Nov. 28, 2022.

(51) Int. Cl. B60L 53/124; H02J 50/40

(52) U.S. Cl. CPC B60L 53/124; H02J 50/40; H02J 50/10; H02J 50/60

(57) ABSTRACT

Wireless power transfer (WPT) systems having first and second primary windings and a secondary load winding are described. The WPT systems are configured such that the mutual inductance between the first and second primary windings is zero or substantially zero and the mutual inductance between each of the first and second primary windings and the load winding is not zero. The systems described are particularly effective in wireless power transfer applications where electromagnetic field exposure as well as the system efficiency may be an issue.

### FIELD

Wireless power transfer (WPT) systems having first and second primary windings and a secondary load winding are described. The WPT systems are configured such that the mutual inductance between the first and second primary windings is zero or substantially zero and the mutual inductance between each of the first and second primary windings and the load winding is not zero. The systems described are particularly effective in wireless power transfer applications where electromagnetic field exposure as well as the system efficiency may be an issue.

### BACKGROUND

Transformers are devices that transfer power from a primary winding/coil to a secondary winding/coil across a non-conducting medium by means of the magnetic field. In a transformer, power applied to the source coil at one voltage is inductively received at the secondary coil at a voltage proportional to the number of turns in each of the primary and secondary windings or in general proportion to the mutual inductance between the primary and secondary windings. Transformers can generate significant magnetic and electric fields that may be harmful to animal and human health.

Exposure of humans to both magnetic and electric fields (referred to herein as “fields” or “electromagnetic (EM) fields (EMFs)”) is governed by international standards and related safety laws and regulations. Electromagnetic field limits established by governing bodies cannot be exceeded by a device or equipment designed for specific commercial or industrial use.

Transformers can be used in a wide range of applications where the electromagnetic fields could be problematic when used near to humans. Generally, the higher the power within the transformer, the higher EM fields. Thus, many transformers are limited in terms of their power by EM field regulations.

An example where relatively high power is transferred and where EMF regulations may limit the amount of power that may be transferred is in the automotive industry and specifically charging electric vehicles (EVs) by wireless inductive coupling.

In a wireless inductive charging system, an EV charging station may have a fixed (or moveable) primary winding (typically configured to the ground) and an EV is fitted with a secondary winding connected to its battery charging system which would typically be located on the underside of the vehicle. In one example, an EV drives over a primary winding and when the primary and secondary windings are properly positioned with respect to one another, power is wirelessly transferred to the EV.

Given the potential that humans will be in close proximity to the windings during this operation, the maximum power that may be transmitted would be limited by regulations that govern human exposure to electromagnetic fields. That is, while charging systems could be designed that allow for higher levels of power to be transferred, regulations would require that only limited levels of power are transmitted due to the EM fields.

Power and/or current control is a goal of many electric systems including systems for electromagnetic and electromechanical applications. Past systems have been designed with primary windings, secondary windings and additional windings.

The prior art shows that control of electromagnetic power between primary, secondary and additional windings may be achieved by a variety of means such as through direct feedback controlling the supply source or indirectly by intermediate means such as, for example, an additional winding linked with the main winding by means of the magnetic flux. Control of this type may be achieved by a variety of means, for example through a feedback loop, closed or open, regulating the supply of power and/or current directly or, alternatively, by intermediate means such as, for example, an additional winding linked with the main winding by means of the magnetic flux.

A review of the prior art illustrates some past approaches.

GB568204A describes a system having an intermediate winding to control motor torque. The intermediate winding supplies a rotor winding in order to either a) increase the torque of the motor when the electric current supplied by the intermediate winding at the motor's main power winding's frequency and out of phase or b) to retard the rotor when the frequency is other than the main power frequency is supplied therein.

In either case, the motor's rotor current control occurs by electrically coupling the windings of the rotor winding and the control winding, which in turn is supplied by the magnetically coupled transformer.

KR102075417 describes a system for stacking traction transformer windings to achieve better coupling and higher impedance to minimize harmonic currents, decrease leakage flux to reduce excessive heating of the magnetic core and a container box structure.

In this system, the windings are coupled by means of the common flux and the nature of this system is to increase the magnetic field coupling between the primary and the secondary windings. An additional winding is tightly coupled to the primary winding and serves to supply auxiliary converters of the locomotive.

U.S. Pat. No. 7,847,664 describes a system to transfer power over magnetically coupled transformer windings to a minimum of two outputs connected to two separate loads having a constant voltage source such as a battery or a capacitor. In this system, provided the battery is being charged it builds bias in a form of a constant component of the magnetic flux. When the battery charges up, the voltage across the coil C1 increases, which decreases the total secondary flux and stops current from flowing. As a result, the controlling sum voltage, and in consequence the flux in the common pool of the secondary coils, depends on the state of charge of the battery causing self-regulation of the input power. This system requires two identical and opposing secondary windings, that must be in an opposition to each other magnetically.

U.S. Pat. No. 10,377,255 describes systems and methods of transferring energy to a car. This system provides coupling between the primary and the secondary windings by shaping the magnetic coupling medium in a particular way. In this system, the coupling between the windings is strong as both are wound on the same core. This system utilizes a control system in which the controlling coil switches the coupling flux on/off in a plurality of segments thus removing them from the single backbone supply circuit when they are not used to transfer power.

U.S. Pat. No. 10,404,100 describes a system for inductive power transfer and a method to limit the magnetic field emissions by means of embedding the coils forming a double D winding in a recessed ferrite structure.

US20220044868 describes systems having magnetic coupling structures facilitating wireless (or inductive) power transfer. This system utilizes an additional leakage control coil substantially decoupled from the main coil by means of a ferrite screen shown in a form of ferrite pieces strategically placed under the middle of a DD winding and at its ends. The benefit of the leakage control (or reflection) coil is that when driven out of phase it decreases the overall magnetic field emissions, but at a cost of increased input power demand.

### SUMMARY

In accordance with the invention, a wireless power transfer (WPT) system is described having a first primary winding circuit having a first AC power system (AC1) and first winding (PW1); a second primary winding circuit having a second AC power system (AC2) and a second winding (PW2); wherein the PW1 and PW2 are spatially positioned with respect to one another where the mutual inductance, M12, between PW1 and PW2 is zero or substantially zero; a secondary winding circuit having a load and secondary winding (SW), the SW spatially positioned adjacent to PW1 and PW2 where the mutual inductance between PW1 and SW is not zero and the mutual inductance between PW2 and SW is not zero; and, a power control system for controlling input AC power to each of AC1 and AC2.

In various embodiments:
AC1 is a voltage regulated AC power source.
AC2 is a current regulated AC power source.
The first primary winding circuit includes a series compensation tuning network having a capacitor C1 in series with PW1.
The secondary winding circuit includes a series compensation tuning network having a capacitor C3 in series with SW.
The second primary winding circuit includes a parallel compensation network having a capacitor C2 in parallel with PW2.
The AC2 supplies current at a frequency equivalent to a voltage frequency of AC1.
AC1 supplies voltage at a characteristic frequency of PW1.
The WPT system includes two or more pairs of a first and secondary primary winding and where the mutual inductance between each first and secondary primary winding is zero or substantially zero.
The WPT system is an electric vehicle charging system and where the first primary winding circuit and second primary winding circuit are ground-mounted and the secondary winding circuit is vehicle-mounted.
The WPT system comprises at least one sensor configured to detect a human or animal within a charging perimeter and wherein the power control system is configured to transfer power at a first power level if a human or animal is within the charging perimeter and at a second power level is a human or animal is outside the charging perimeter.

### BRIEF DESCRIPTION OF THE DRAWINGS

Various objects, features and advantages of the invention will be apparent from the following description of particular embodiments of the invention, as illustrated in the accompanying drawings. The drawings are not necessarily to scale, emphasis instead being placed upon illustrating the principles of various embodiments of the invention. Similar reference numerals indicate similar components.

FIG. 1 is a schematic diagram of a wireless power transfer system in accordance with one embodiment.

FIG. 2 is a schematic diagram of two theoretical windings showing analysis variables for windings having zero mutual inductance.

FIG. 3 is a plan view of two representative primary windings showing spatial offsets.

FIG. 4 is a schematic diagram of a wireless power transfer system having series and parallel compensated tuning networks in accordance with one embodiment.

FIG. 5 is a schematic side view of ground mounted dual primary side windings and vehicle mounted secondary winding with offset S in accordance with one embodiment.

FIG. 6 is a schematic plan view of ground mounted dual primary windings in accordance with one embodiment.

FIG. 7 is a schematic plan view of vehicle mounted dual secondary windings in accordance with one embodiment.

FIG. 8 is a schematic plan view of an electric vehicle charging station having a charging perimeter accordance with one embodiment.

### DETAILED DESCRIPTION

The inventors have recognized and identified a need for wireless power transfer systems for inductive transfer of power between primary and secondary windings while minimizing associated EM fields and optimizing the power electronics of the WPT system. The inventors have recognized that wireless power systems having two primary windings can be spatially oriented with respect to one another with the mutual inductance between these windings being zero or substantially zero which allows power transfer to a secondary or load winding with lower EM fields and/or automatic load distribution and sharing to optimize the cost of the power transfer system.

### Scope of Language

Within this description, all terms have definitions that are reasonably inferable from the drawings and description, with the language used herein to be interpreted to give as broad a meaning as is reasonable.

Within this application, reference is made to various numbers and number ranges. Numbers or number ranges are to be interpreted with the understanding that numbers are defining possible boundaries or variables related to particular features described herein. Boundaries are not necessarily fixed and may be affected by relationships with one or more other features. Thus, use of terms like “about” or other modifiers in this description are intended to provide allowance for the potential interplay of variables or features with respect to one another and should be interpreted in that light. Features described herein are understood to provide collective functionality with one another. At a minimum, numbers are to be interpreted having regard to their significant digits.

### Introduction

Various aspects of the invention are described with reference to the figures. For the purposes of illustration, components depicted in the figures are not necessarily drawn to scale. Instead, emphasis is placed on highlighting the various contributions of the components to the functionality of various aspects of the invention. A number of possible alternative features are introduced during the course of this description. It is to be understood that, according to the knowledge and judgment of persons skilled in the art, such alternative features may be substituted in various combinations to arrive at different embodiments.

### Overview

Wireless power transfer (WPT) systems are described enabling wireless power transfer from two primary windings to a secondary receiver winding.

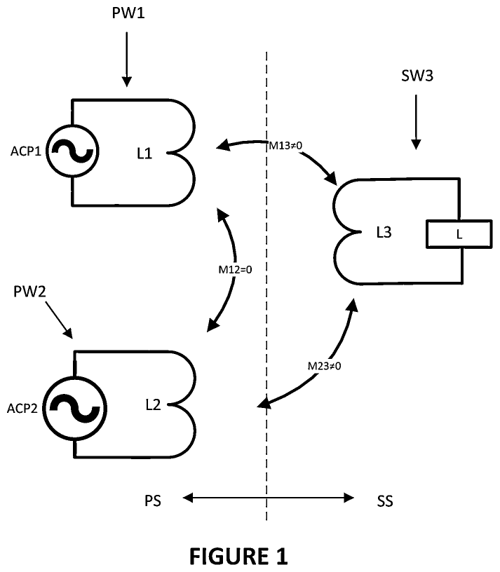

As shown in FIG. 1, the WPT system 10 includes a primary circuit PW1, a second primary or control circuit PW2 and a secondary or load circuit SW3, collectively the WPT circuits. PW1 includes an AC power supply ACP1 and winding L1 and PW2 includes an AC power supply ACP2 and winding L2. Collectively, PW1 and PW2 are referred to as the primary side PS of the WPT and SW3 is referred to as the secondary side SS of the WPT. SW3 includes a winding L3 and load L. Within this description, ACP1 is generally a voltage source whereas ACP2 is a current source.

As explained below, the spatial positioning of PW1 and PW2, and specifically, L1 and L2, is such that the mutual inductance, M, between these two windings, referred to as M12 is zero. The mutual inductance M13, between PW1 and SW3 is not zero and the mutual inductance M23, between PW2 and SW3 is not zero.

Under these conditions, each of PW1 and PW2 can be operated such that for a given power output of ACP1 and ACP2, the total power received at the load L on SW3 is substantially the sum of power output of ACP1 and ACP2 whereas the total electromagnetic field (EMF) at a given time is substantially no greater than the EMF generated by the operation of ACP1 and ACP2 individually.

In various embodiments, systems and methods of controlling each of the WPT circuits are described. In addition, methods of designing and designs of WPTs are described. The systems and methods described can enable higher power transfer compared to a single primary winding power transfer system without exceeding threshold EM field limits.

### Mutual Inductance of PW1 and PW2

As shown in FIG. 1, the WPT system is designed such that mutual inductance M12 between coils L1 and L2 is zero or substantially zero. For the purposes of discussion, this feature will be referred to as zero. The inventors have determined that two independently powered coils of arbitrary design can be positioned in 3D space with a mutual inductance of zero. As is known, in general, the magnetic coupling between any two coils is not zero. In addition, in a typical WPT system, the primary side has a single primary winding.

In the past, for WPT systems that may have more than one primary side winding, the mutual inductance between such windings is not zero which can provide other effects.

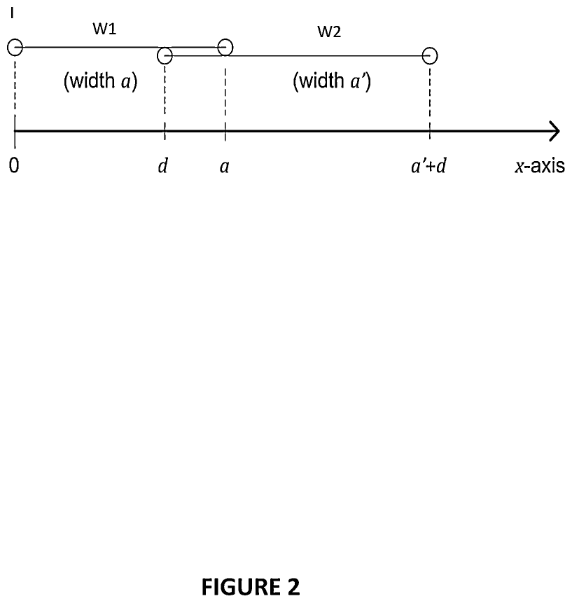

It is possible to create two windings with a magnetic coupling coefficient k=0. This coefficient is defined as:

$$k = \frac{M}{\sqrt{{L}_{1} {L}_{2}}} ,$$

where M is the mutual inductance and is the measure of how well the two windings of self-inductances L₁, L₂ share their magnetic flux. When the net flux coupled with the other winding from the current of the first winding is zero, the mutual inductance M is also zero. With reference to FIG. 2, an example of two theoretical windings in 2D space is illustrated.

W1 and W2 are two windings, shown in cross-section and illustrated as infinitely long, extending from the plane of the figure and perpendicular to the x-axis.

The magnetic net flux associated with W2 from current flowing in W1 can be zero at a particular distance d, and as a function of the coil widths a, a′. The distance d is calculated as described below:

The net flux, Φ, in the W2 from W1 is the sum of fluxes generated by the complementary currents, I, of W1:

$${Φ}_{21} = {\int }_{d}^{d + {a}^{′}} \frac{{μ}_{0} \cdot I}{2 \cdot π \cdot x} \cdot dx = \frac{{μ}_{0} I}{2 π} ln \frac{d + {a}^{′}}{d}$$

$${Φ}_{22} = - {\int }_{a - d}^{{a}^{′} - ( a - d )} \frac{{μ}_{0} \cdot I}{2 \cdot π \cdot x} d x = \frac{{μ}_{0} I}{2 π} ln \frac{a - d}{{a}^{′} - ( a - d )}$$

μ₀ is permeability of free space.

In order that the mutual inductance between the two windings be zero, the net flux of W2 from W1 is zero for any non-zero current of W1:

$${Φ}_{2} = {Φ}_{21} + {Φ}_{22} = \frac{{μ}_{0} I}{2 π} ( ln \frac{d + {a}^{′}}{d} + ln \frac{a - d}{{a}^{′} - ( a - d )} )$$

Solving equation Φ₂=0 for d:

$$\frac{d + {a}^{′}}{d} . \frac{a - d}{{a}^{′} - ( a - d )} = 1$$

$$and :$$

$$d = \frac{1}{2} [ - ( {a}^{′} - a ) + \sqrt{{( {a}^{′} - a )}^{2} + 2 {a}^{′} a} ]$$

Thus, in the particular case of identical windings, where

$${a}^{′} = a , d = \frac{1}{\sqrt{2}} a .$$

This distance tends to d=a when the depth of the winding tends to zero.

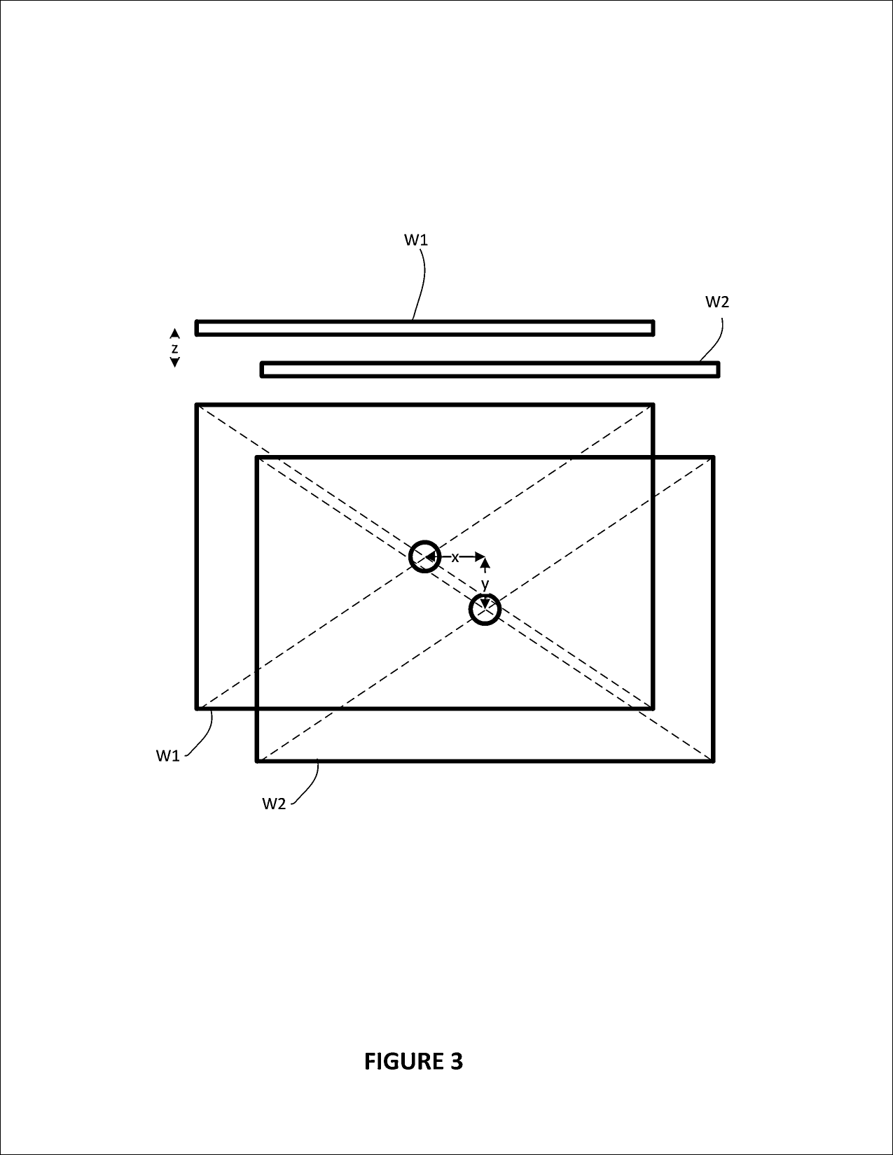

In this example, analytical calculations of the condition M=0 are shown using simplified windings for the ease of the calculations. However, the condition of M=0 can be achieved for any circuit, such as those shown in FIG. 3 having a rectangular shape, or generally random-shaped windings through which current can be made to pass.

FIG. 3 illustrates two non-idealized windings in a representative relative position that fulfills the condition of M=0. During the design process, finite element analysis (FEA) can be utilized for specific coil designs such as two flat coils to determine a spatial condition when M=0.

In one example, two planar square coils with outer dimensions of 200×200×4 mm were modelled to demonstrate the function of winding lateral displacement versus their fill factor to obtain zero mutual inductance. Fill factor is generally referred to as the ratio between a conductor's area (e.g. a perimeter area) relative the cross sectional area of the conductor.

In this example, fill factor is calculated as the area filled with a conductor (e.g. copper) inside the 200 mm square frame divided by 200². In this example, FEA analysis was initialized at a fill factor of 0.02 equivalent to conductor width of 1 mm.

As shown in FIG. 3, which shows windings W1 and W2 in a side view and plan view, a condition exists where the two windings are spatially displaced from one another at distances x, y and z where M=0.

### Mutual Inductance Between PW1, PW2 and SW3

Referring back to FIG. 1, mutual inductance M12 is zero or substantially zero and mutual inductances M13 and M23 are not zero such that selectively powering PW1 does not induce voltage/current in PW2 and vice versa. However, selectively powering PW1 or PW2 does induce voltage/current in SW3.

### PW1 and PW2 Input Power and Control

Power to PW1 and PW2 is controlled such that power to the load is shared with an inherently constant load.

In various embodiments, controlling power input to PW1 and PW2 enables ZCS (Zero Current Switching), without impacting the load current in SW3.

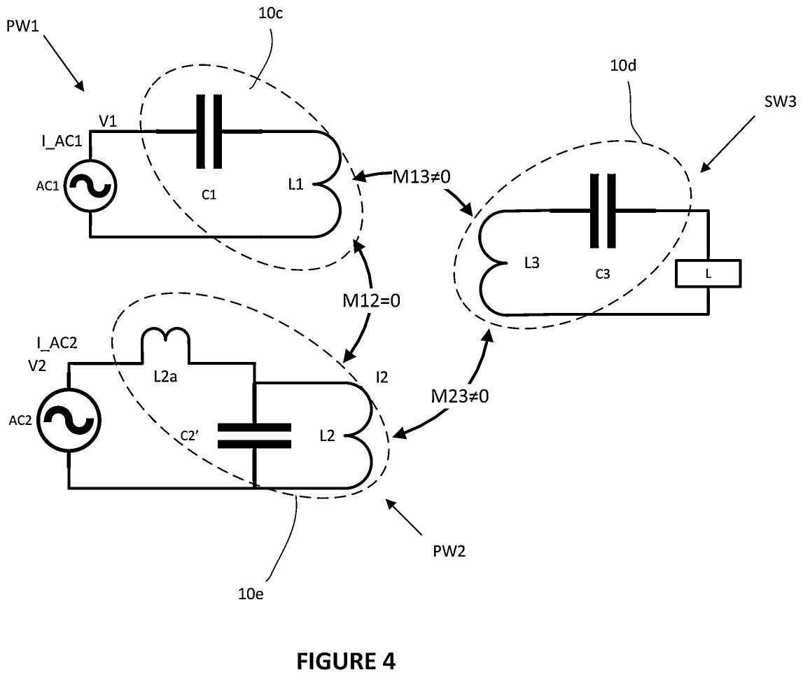

In one embodiment, as shown in FIG. 4, PW1 includes a first series compensation tuning network 10c, PW2 includes a parallel compensation tuning network 10e and SW3 includes a second series compensation tuning network 10d.

The first tuning network 10c includes capacitor C1 in series with L1. Generally, L1 has a self-inductance namely, the measure of inductive energy that can be stored in the magnetic field of the inductor which can be compensated with C1 in series. Voltage source power is supplied to PW1 via AC1 (I_AC1 and V1) operating substantially close to the characteristic frequency of L1, C1.

The second tuning network 10d includes capacitor C3 in series with L3. SW3 has load L, (e.g. a resistor) which can convert electric current into another form of energy. Ideally,

$$1 / √ ( L {1}^{⋆} C 1 ) = 1 / √ ( L {3}^{⋆} C 3 ) .$$

As M13 is not zero, power is transferred to SW3.

The parallel compensation tuning network 10e of PW2 includes capacitor C2′ in parallel with winding L2 and a decoupling inductor L2a. In one embodiment, PW2 is powered with voltage source AC2 (I_AC2 and V2) resulting in alternating current of amplitude I2 and frequency ω at L2, equal to the frequency of the voltage source of PW1.

By controlling a) the current I2 to PW2 or b) the phase relation of AC1 and AC2, power is transferred to SW3 with lower EMF as compared to transferring the equivalent power through PW1 alone.

When PW1 is supplied with AC voltage and SC3 provides a load, a change of a) current amplitude I2 or b) the phase relation between I2 and the AC1 voltage source does not change the load power.

In another embodiment, AC1 is a voltage source and AC2 is a voltage source operating to provide a constant current I2 and will adjust the voltage to provide the current. Hence, for a given load at SW3, each of AC1 and AC2 will “find a balance” where the AC1 and AC2 voltages will provide the load power. If there is a change in the load, each of AC1 and AC2 will find a new balance.

In another embodiment, EMF can be proportional to the ratio of the load contribution generated by each power source AC1 and AC2. In some embodiments, this could be around 50% of what would be generated compared to sending all the source power through just one winding. With M12=0, substantially all the source power is transferred from PW1 and PW2 without losses/interference to/from the load.

In another embodiment, when PW1 is supplied with AC voltage and SW3 provides load, a change in a) current amplitude I2 or b) phase relation between I2 and the voltage source to PW1 or c) both, does not change the load current phase relation to voltage source AC1.

In another embodiment, if I2 is in phase with AC voltage source AC1 or 180° out of phase, the zero crossing of the voltage source AC1 and its current occur at substantially the same instant. This allows for zero current switching (ZCS) for the current source AC2.

In another embodiment, if I2 and the AC voltage source current AC1 are in phase or 180° out of phase, the voltage of the AC2 is in phase with the current of AC2. This allows for zero current switching (ZCS) for the current source AC2.

The regulation of the WPT primary winding current by means of a decoupled dual primary winding is shown as follows where:
Eₐ, E_{b}, E_{c} are the electro-motoric forces induced in the first primary (subscript a), the second primary (subscript b), and the secondary (load) currents (subscript c), respectively.
Ψ_{c} is the magnetic flux linked with secondary (load) winding (subscript c);
iₐ, i_{b}, i_{c} are the first primary (subscript a), the second primary (subscript b), and the secondary (load) currents (subscript c), respectively;
Uₐ, U_{b} are source voltages for the first primary and the second primary winding respectively;
j is a complex number operator;
ω is angular frequency of the source; and,
M is a mutual inductance.

$$\begin{matrix}{E}_{c} = - \frac{d {Ψ}_{c}}{d t} \\ {E}_{c} = - j {M}_{a c} {i}_{a} - j ω {M}_{b c} {i}_{b} = - j ω ( {M}_{a c} {i}_{a} + {M}_{b c} {i}_{b} ) \\ {i}_{c} = - \frac{j ω ( {M}_{a c} {i}_{a} + {M}_{b c} {i}_{b} )}{{R}_{L}} \\ {E}_{a} = - j ω {M}_{a c} {i}_{c} = - \frac{{ω}^{2} {M}_{a c} ( {M}_{a c} {i}_{a} + {M}_{b c} {i}_{b} )}{{R}_{L}} \\ {E}_{b} = - j ω {M}_{b c} {i}_{c} = - \frac{{ω}^{2} {M}_{b c} ( {M}_{a c} {i}_{a} + {M}_{b c} {i}_{b} )}{{R}_{L}}\end{matrix}$$

Due to added tuned capacitance in the primary coil:

$${U}_{a} + {E}_{a} = 0$$

$${U}_{a} = \frac{{ω}^{2} {M}_{a c} ( {M}_{a c} {i}_{a} + {M}_{b c} {i}_{b} )}{{R}_{L}}$$

From the above current iₐ is as follows:

$${i}_{a} = \frac{{U}_{a} {R}_{L}}{{( ω {M}_{a c} )}^{2}} - \frac{{M}_{b c}}{{M}_{a c}} {i}_{b}$$

Current i_{b} results from the topology of the circuit:

$${i}_{b} = \frac{{U}_{b}}{j ω {L}_{b}}$$

Substituting i_{b} to the expression for iₐ obtains:

$${i}_{a} = \frac{{U}_{a} {R}_{L}}{{( ω {M}_{a c} )}^{2}} - \frac{{M}_{b c}}{{M}_{a c}} \cdot \frac{{U}_{b}}{j ω {L}_{b}}$$

Substituting i_{b} and iₐ to an expression for i_{c}, obtains:

$$\begin{matrix}{i}_{c} = - \frac{j ω ( {M}_{a c} ( \frac{{U}_{a} {R}_{L}}{{( ω {M}_{a c} )}^{2}} - \frac{{M}_{b c}}{{M}_{a c}} \cdot \frac{{U}_{b}}{j ω {L}_{b}} ) + {M}_{b c} \frac{{U}_{b}}{j ω {L}_{b}} )}{{R}_{L}} \\ {i}_{c} = - \frac{j ω ( \frac{{U}_{a} {R}_{L}}{{ω}^{2} {M}_{a c}} )}{{R}_{L}} \\ {i}_{c} = - j ( \frac{{U}_{a}}{ω {M}_{a c}} ) \\ {i}_{c} = \frac{{U}_{a}}{j ω {M}_{a c}}\end{matrix}$$

In conclusion, the load current, i_{c}, is independent of U_{b} and, the power coming from current iₐ, could be seen by the source as resistive, if only U_{b} is advanced/delayed with respect to Uₐ.

For example, if U_{b}=jωkUₐ, where k is a real number, current iₐ equals:

$$\begin{matrix}{i}_{a} = \frac{{U}_{a} {R}_{L}}{{( ω {M}_{a c} )}^{2}} - \frac{{M}_{b c}}{{M}_{a c}} \cdot \frac{j ω k {U}_{a}}{j ω {L}_{b}} \\ {i}_{a} = \frac{{U}_{a} {R}_{L}}{{( ω {M}_{a c} )}^{2}} - \frac{{M}_{b c}}{{M}_{a c}} \cdot \frac{k {U}_{a}}{{L}_{b}}\end{matrix}$$

In this example, current is in phase with voltage and the main power source sees the load as a resistor.

Further, the derived dependences can be confirmed by circuit simulation performed using commercially available circuit applications.

Thus, by controlling the second primary winding voltage it is possible to decrease the emissions caused by the concentrated first primary winding and allows for higher power transfer while maintaining the magnetic field emissions level unchanged.

### System Design and Applications

As described above, reference has been made to a single primary winding PW1 and a single second primary or control winding PW2 as one operative unit.

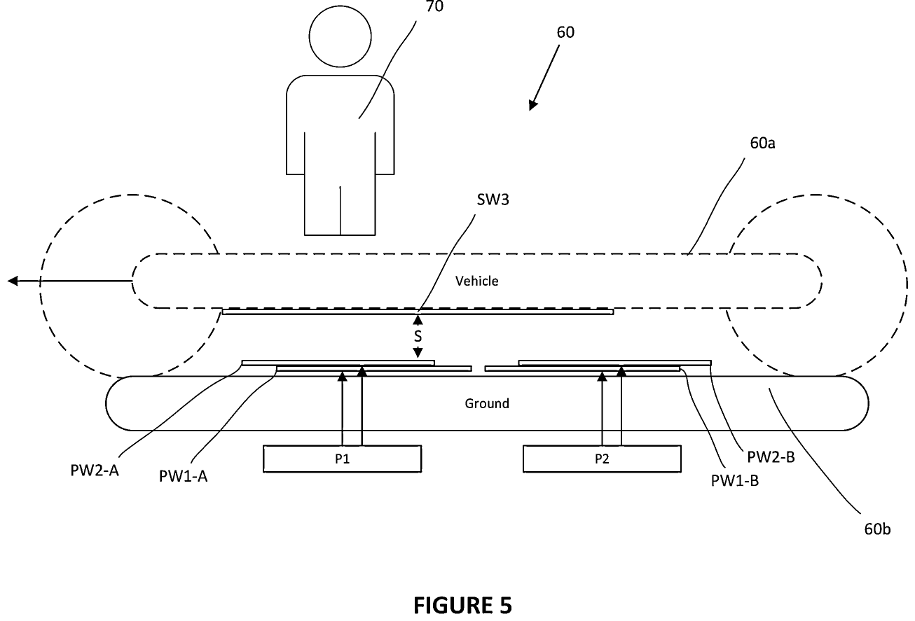

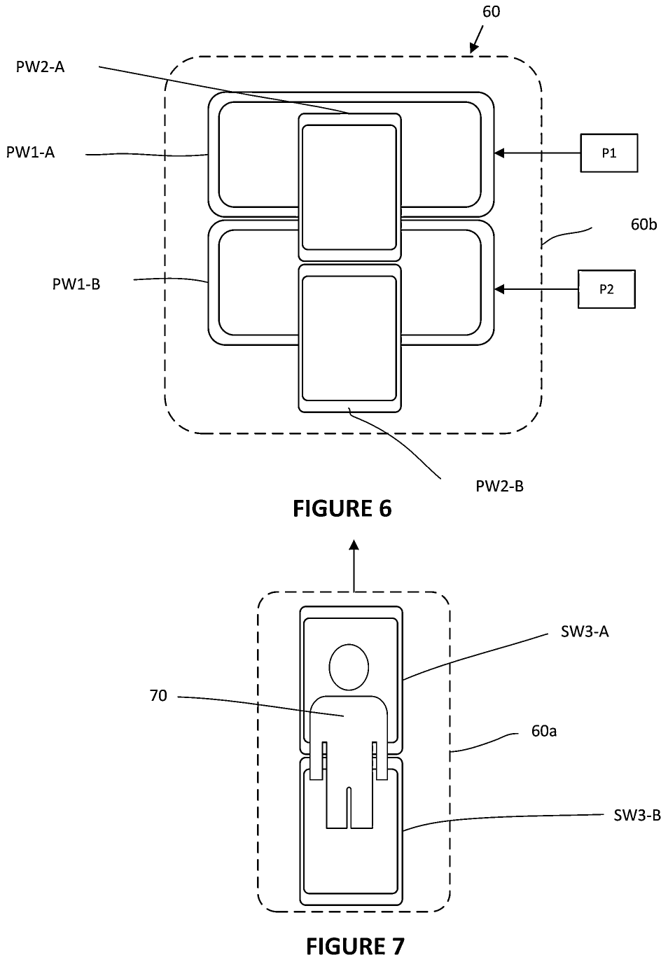

However, it is understood that systems utilizing pairs of more than one primary winding and more than one control winding are contemplated, provided that the combination of each pair of primary and control windings have the M=0 relationship described herein and shown in FIGS. 5-8.

For a given power transfer application, the design of a particular system having one or more pairs of primary windings (PW1/PW2) and one or more pairs of secondary windings (SW3) may include the following general steps including a) determining the desired power parameters at the load SW3 and an acceptable EMF, b) determining PW1 and PW2 winding design where M=0 for desired load at SW3 and c) determining a control system design.

For example, a charging station for an electric vehicle may desire that the charging power is 50 KW and that EMF is below 6.25 uH with humans 70 in proximity to the windings. The charging station may enable the charging power to be higher if the system determines that humans are not in proximity. Based on these parameters, the designer can determine the size/shape and offset of the primary windings such that the mutual inductance of PW1 and PW2 is zero and that the EMF is below a particular threshold. The design of the control system may ensure that the power transfer and EMF is maintained below thresholds based on various inputs including the presence of humans.

FIGS. 5-8 show a representative charging station 60 for charging an electric vehicle 60a with ground 60b mounted primary windings. The charging station may have one or more primary winding pairs (e.g. PW1-A, PW2-A and PW1-B, PW2-B) positioned in the ground with corresponding power sources P1 and P2 as shown in FIGS. 5, 6 and 8. An EV 60a may be fitted with one or more secondary windings (SW3-A, SW3-B) that are configured to the EV's battery charging system (not shown).

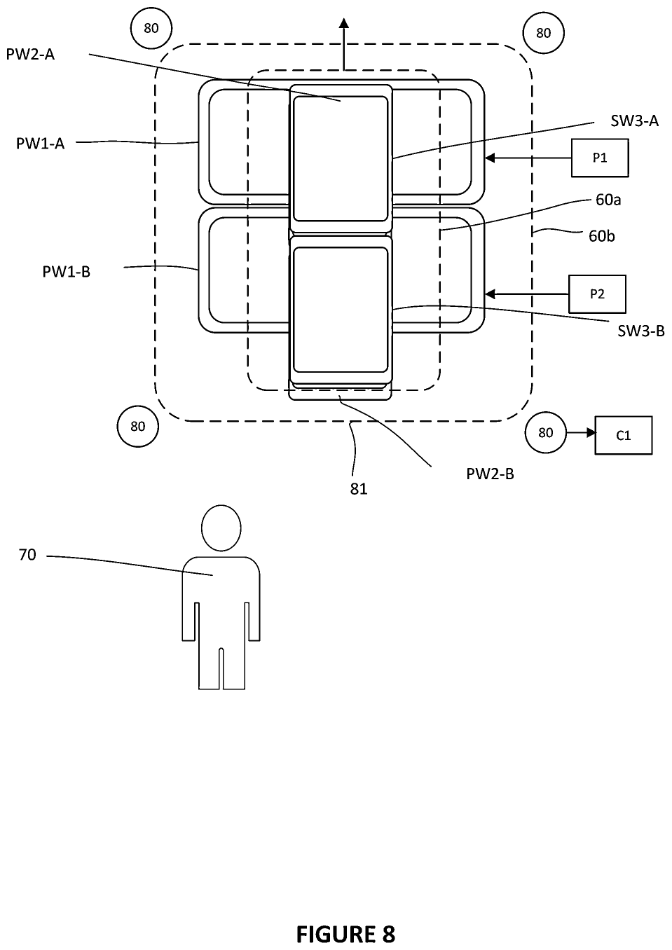

The EV may drive over the primary windings so as to position the secondary windings(s) over the primary windings in an operative position to enable charging of the EV (FIGS. 5 and 8).

In one example, the vehicle can be fitted with the magnetic field sensors feeding the measured field information back to the primary winding controls to limit the field in the presence of humans by ramping up power in the second primary winding maintaining appropriate phase relation between AC1 and AC2 voltage sources. For example, such sensors could be placed on the bottom part of the chassis on the periphery of the car where the human would be exposed to the highest EMF.

As shown in FIG. 8, an EV charging system may be configured with one or more sensors 80 configured to detect the presence of humans 70 within a particular area 81 wherein if one or more humans 70 is within the area, the WPT is reduced and if the control system C1 detects that the humans have left the area, WPT is increased based on EMF thresholds.

That is, upon arrival at a charging station, a driver may drive their vehicle to the correct position to enable charging to occur. The vehicle may be occupied by only the driver or may be occupied with other humans or animals. The driver, for example, may engage the charging system through various means including app-based activation systems or external activation systems to initiate vehicle charging.

In various operational scenarios, the vehicle occupants may all remain in the vehicle, one or more may leave the vehicle or all may leave the vehicle.

Through various means, the system may determine if one or more occupants are present in the vehicle. If a control system C1 determines that any occupants are in the vehicle, the system may commence WPT at a first threshold level. Alternatively, if the system determines no humans or animals are present, WPT may be increased to a second threshold level.

In various embodiments, the system may also monitor an EMF perimeter 81 with one or more sensors 80 that may be configured to determine the presence or absence of humans/animals within the EMF perimeter and adjust the WPT power accordingly. Sensors 80 may include various combinations of motion, capacitive, infra-red sensors and the like to determine the presence or absence of humans/animals within the EMF perimeter and/or the vehicle.

Although the present invention has been described and illustrated with respect to preferred embodiments and preferred uses thereof, it is not to be so limited since modifications and changes can be made therein which are within the full, intended scope of the invention as understood by those skilled in the art.

1. A wireless power transfer (WPT) system comprising:
a first primary winding circuit having a first AC power system (AC1) and first winding (PW1);
a second primary winding circuit having a second AC power system (AC2) and a second winding (PW2);
wherein the PW1 and PW2 are spatially positioned with respect to one another where the mutual inductance, M12, between PW1 and PW2 is zero or substantially zero;
a secondary winding circuit having a load and secondary winding (SW), the SW spatially positioned adjacent to PW1 and PW2 where the mutual inductance between PW1 and SW is not zero and the mutual inductance between PW2 and SW is not zero; and,
a power control system for controlling input AC power to each of AC1 and AC2.

2. The WPT system as in claim 1 wherein AC1 is a voltage regulated AC power source.

3. The WPT system as in claim 1 wherein AC2 is a current regulated AC power source.

4. The WPT system as in claim 1 wherein the first primary winding circuit includes a series compensation tuning network having a capacitor C1 in series with PW1.

5. The WPT system as in claim 1 wherein the secondary winding circuit includes a series compensation tuning network having a capacitor C3 in series with SW.

6. The WPT system as in claim 1 wherein the second primary winding circuit includes a parallel compensation network having a capacitor C2 in parallel with PW2.

7. The WPT system as in claim 1 wherein the AC2 supplies current at a frequency equivalent to a voltage frequency of AC1.

8. The WPT system as in claim 1 wherein AC1 supplies voltage at a characteristic frequency of PW1.

9. The WPT system as in claim 1 wherein the WPT includes two or more pairs of a first and secondary primary winding and where the mutual inductance between each first and secondary primary winding is zero or substantially zero.

10. The WPT system as in claim 1 wherein the WPT is an electric vehicle charging system and where the first primary winding circuit and second primary winding circuit are ground-mounted and the secondary winding circuit is vehicle-mounted.

11. The WPT system as in claim 10 further comprising at least one sensor configured to detect a human or animal within a charging perimeter and wherein the power control system is configured to transfer power at a first power level if a human or animal is within the charging perimeter and at a second power level is a human or animal is outside the charging perimeter.

12. The WPT system as in claim 2 wherein AC2 is a current regulated AC power source.

13. The WPT system as in claim 12 wherein the first primary winding circuit includes a series compensation tuning network having a capacitor C1 in series with PW1.

14. The WPT system as in claim 13 wherein the secondary winding circuit includes a series compensation tuning network having a capacitor C3 in series with SW.

15. The WPT system as in claim 14 wherein the second primary winding circuit includes a parallel compensation network having a capacitor C2 in parallel with PW2.

16. The WPT system as in claim 15 wherein the AC2 supplies current at a frequency equivalent to a voltage frequency of AC1.

17. The WPT system as in claim 16 wherein AC1 supplies voltage at a characteristic frequency of PW1.

18. The WPT system as in claim 17 wherein the WPT includes two or more pairs of a first and secondary primary winding and where the mutual inductance between each first and secondary primary winding is zero or substantially zero.

19. The WPT system as in claim 18 wherein the WPT is an electric vehicle charging system and where the first primary winding circuit and second primary winding circuit are ground-mounted and the secondary winding circuit is vehicle-mounted.

20. The WPT system as in claim 19 further comprising at least one sensor configured to detect a human or animal within a charging perimeter and wherein the power control system is configured to transfer power at a first power level if a human or animal is within the charging perimeter and at a second power level is a human or animal is outside the charging perimeter.
